(19) United States
(12) Patent Application Publication
(10) Pub. No.: US 2007/0290838 A1
(43) Pub. Date: Dec. 20, 2007

(54) Secure surveillance system

(76) Inventor: Aberleno Frederic, F-13510 Eguille, France French (FR)

Correspondence Address: Horst M Kasper, 13 Forest Drive, Warrer, NJ, 07059, US

(21) Appl. No.: 11/658,296

(22) PCT Filed: Jul. 20, 2005
(86) PCT No.: PCT/FR05/01874

§ 371 Date: Jan. 22, 2007

(30) Foreign Application Priority Data
Jul. 20, 2004 (FR) 0407996

(51) Int. Cl. G08B 1/08; G08B 23/00

(52) U.S. Cl. 340/539.13; 340/573.1; 340/539.15

(57) ABSTRACT

The invention relates to a surveillance system wherein a localisation terminal TL and a surveillance terminal cooperate. Each terminal TL comprises: means for the acquisition M1L of a localisation message; communication means MRL-ARL; and control means MCL for connecting the acquisition means and the communication means in response to an activation signal. Said terminal also comprises a co-ordination body MCL for automatically producing the activation signal, the control means being activated if, and only if, the activation signal is present.

The present invention relates to a secure surveillance system.

The scope of this invention is especially that of the surveillance of a living creature moving about against the will of the person having custody over it. One thinks immediately of a child moving away from its parents.

In such a situation, it is appropriate to indicate as soon as possible the distance between the entity under surveillance and the overseeing entity, at the very least to communicate its position to the latter, so that it can initiate a search procedure.

A first known surveillance system uses a telecommunications infrastructure including a radio communications network and a wired network, interconnected together. The entity under surveillance, a child for example, is equipped with a locating terminal consisting in a mobile phone coupled to a “GPS” receiver. The term GPS (which stands for “Global Positioning System”) describes a whole array of satellites that broadcast signals enabling the receiver to obtain its space coordinates.

The overseeing entity, one of the parents for example, has in his/her possession a surveillance terminal that can take the form of a phone or a personal computer connected to the internet network. In order to obtain the child's position, the father or mother gains access to a server using his/her surveillance terminal. The server contacts the child's locating terminal, which terminal delivers the child's position by means of the GPS receiver. The server then transmits this information to the surveillance terminal through two networks.

In the first place, the locating terminal uses a radio communications network, which substantially limits the assets of this surveillance system:
this terminal must be situated within the coverage area of this network, which is rarely the case in areas that are not densely populated but where it is common though to go out for a walk;
even in case the terminal is within the coverage area, a network outage can take place, be it as a result of temporary overloading or technical problems;
one has to take a subscription with a Telecom operator for this network, even if the surveillance operations are not frequent, involving a cost that is far from being negligible.

In the second place, the link bringing together the two terminals includes many elements, which also is detrimental to security.

In the third place, that system leaves the initiative of the child's surveillance to one of the child's parents. As long as the latter does not connect to the server, he or she does not know the child's position. This obviously constitutes a breach at the security level.

A second known surveillance system uses a point-to-point radio transceiver coupled to a GPS receiver. In the United States of America, this system makes it possible to communicate via channels reserved for the so-called “Citizen Band” (an amateur radio system known as “CB”). Thus, by using channels of the “FRS” type (for “Family Radio Services”) in the 460 MHz UHF band, the coverage length amounts to 3 km.

This second system has the double advantage of not using a network and having no interposed elements between the locating terminal and the surveillance terminal.

Nonetheless, a first issue is that the locating terminal only transmits the position of the entity under surveillance if said entity has pressed a button. The initiative for such a transmission is then left to the entity under surveillance.

The first objective of the present invention is then a surveillance system offering reinforced security.

According to this invention, a locating terminal incorporates:
acquisition means for acquiring a locating message,
communication means,
control means for connecting these acquisition means and these communication means in response to an activation signal;
   moreover, the terminal comprises a coordination unit to automatically produce the activation signal, the control means being activated if and only if such activation signal is present.

As a result of this, the locating message is transmitted to the surveillance terminal independently from the will of the entity under surveillance. The child doesn't have to press a key for the parent(s) to know its position.

The locating terminal according to this invention also allows for surveillance of living creatures that are not in a position to press a key, or even of non-sentient objects. This might be the case of a dog that takes advantage of being left unattended by his master to chase a rabbit, or of a bicycle that is being ridden not by its owner but by some dishonest fellow.

Preferably, in the locating terminal according to this invention, the activation signal coincides with a predetermined time interval of a repetitive frame synchronised on a clock signal.

In this case, the terminal comprises means for positioning this predetermined time interval within the frame.

According to an additional feature of this invention, this frame including a first subframe made up of allocated time intervals and a second subframe made up of priority time intervals, the predetermined time interval is an allocated time interval.

The second subframe is intended to handle emergency situations.

Indeed, advantageously, the two subframes are interleaved.

As an example, the frame which lasts 30 seconds, contains 30 allocated time intervals of 500 ms each, and 30 priority time intervals of 500 ms each.

Within the locating terminal:
the acquisition means come after spotting means that receive a reception signal coming from a positioning system, and
the communication means are radio transmission means.

Also, the locating message contains information relating to the position of the terminal.

As the case may be, this locating message also includes information relating to this terminal identification.

In addition, as the reception signal contains synchronisation information, the terminal comprises means for generating the activation signal in response to this synchronisation information.

If the frame contains two subframes, the terminal preferably comprises means to also produce the activation signal, in response to an alarm signal, at least within the nth priority time interval following the occurrence of this alarm signal (n being a predetermined number), and it comprises means to introduce an alarm word within the locating message.

As a result, it is not necessary to wait for the next allocated time interval of the terminal, which can come about no later than 30 seconds at most after the occurrence of an alarm signal, before transmitting the alarm word.

It is then desirable for the terminal to comprise means of repeating this alarm word within the first allocated time interval following the nth priority time interval.

According to a first possible scenario, the alarm signal originates from an immersion detector.

According to a second possible scenario, the alarm signal originates from a shock detector.

In the second place, the second known surveillance system requires action on the part of the overseeing entity in order for it to be informed about the position of the entity under surveillance.

Thus, the second object of this invention is to improve this situation.

According to the present invention, just as the locating terminal, a surveillance terminal comprises:
acquisition means for acquiring a locating message,
communication means,
control means for connecting these acquisition means and these communication means in response to an activation signal;

moreover, the surveillance terminal comprises a co-ordination unit to automatically generate the activation signal, the control means being activated if and only if this activation signal is present.

In this surveillance terminal:
the acquisition means consist in a memory, and
the communication means are reception means.

According to a first option, the locating message comprising some identifying information, the reception means functioning uninterruptedly, this terminal includes another memory inside which an identification value is stored, the activation signal being generated by a co-ordination unit in the event of a match between the identifying information and the identification value.

According to a second option, the activation signal coincides with a predetermined time interval of a repetitive frame synchronised on a clock-signal.

In this case, the surveillance terminal comprises means for, positioning this predetermined time interval within the frame.

Whatever the option selected, according to a preferred embodiment, the terminal comprises determination means to generate a situation message in response to a reception signal coming from a positioning system.

Here too, the reception signal comprising some synchronisation information, the terminal comprises means to generate the activation signal in response to such synchronisation information.

In this way, the locating message comprising some position information, the situation message comprising some spot information, this terminal comprises means for calculating the distance between that position and that spot.

Then, the surveillance terminal generates a warning signal if this distance exceeds a first predetermined threshold, this distance being a first measurement.

Therefore the overseeing entity has no special action to perform to be warned about an unexpectedly remote location of the entity under surveillance. The child's father or mother can quietly fall asleep on the beach as he/she will be informed if the child wanders too far away.

Likewise, the surveillance terminal generates a warning signal if the traveling speed of the position exceeds a second predetermined threshold, this speed being a second measurement.

Advantageously, the terminal comprises display means for one of these two measurements at least.

Preferably, the surveillance terminal comprising a compass, it also comprises a servo-control module of the display means on this compass.

Additionally, the surveillance terminal comprises indicating means of the direction in which the entity under surveillance is located.

When the frame contains two subframes, the locating message comprising an alarm word, the surveillance terminal comprises means for also generating the activation signal in response to this alarm word.

The surveillance terminal then comprises means for generating a warning signal in response to this alarm word.

Moreover, the surveillance terminal comprises means for identifying a free allocated time interval, which allows for the synchronisation of the locating terminal.

The present invention will now be described in more detail by describing a possible embodiment, by way of example, with reference to the appended figures representing:

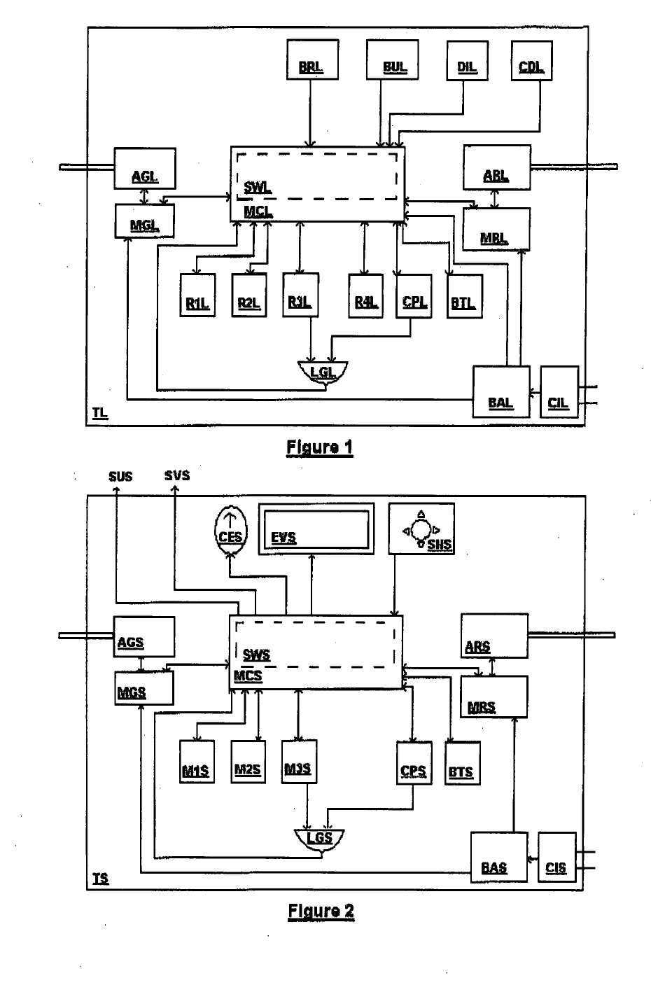

FIG. 1: a diagram of a locating terminal, and

FIG. 2: a diagram of a surveillance terminal.

As regards hertzian wave communications, the frequency spectrum is such a precious commodity that it forms the subject of strict regulations. Accordingly, this spectrum is distributed between numerous applications such as radio broadcasting, television broadcasting, amateur radio systems, point-to-point communications between two terminals (walkie-talkies for example), wireless phone communications, mobile phones, links via satellite for communication systems, radio guidance, and remote controls for a wide range of appliances, not to mention military applications. All of these applications are subjected to a regulatory authorisation.

By way of example, in the United States of America, the FRS system encompasses 14 channels in the 460 MHz UHF band. This type of short distance direct communication makes it possible to do without “heavy” networks of the GSM type.

In addition to the preceding applications, it can frequently happen that at least one narrow band channel be made available for free usage providing that certain conditions be met, such as:
maximum transmission power,
maximum pass band width,
usage time quota.

As an example, in France, we can freely use the channel called “Band 869-600 mW” with a central frequency of 869 MHz. In actual facts, this channel extends from 869.40 MHz to 869.65 MHz.

The present invention takes advantage of this possibility by implementing a time multiplexing of this channel used at a flow rate of 1,200 bits per second. A frame is thus defined in which to fit the messages traveling between terminals.

To put it simply, a frame is subdivided into a plurality of time intervals which each correspond to a subchannel. Each subchannel is capable of supporting unidirectional communication between two terminals. In order to be able to identify the subchannel allocated to them, these terminals must have a common time reference or, in other words, they must be synchronised on the frame.

Several known techniques make it possible to synchronism a terminal to the other. They won't be described in any more detail, as they belong to the state-of-the-art.

Another technique consists in separately synchronising the two terminals to a time signal which constitutes a common reference. One may think in the first place of the GPS system which delivers a universal time whose precision is of the order of the nanosecond. This precision is remarkable and it is obviously quite sufficient for implementing this invention.

According to a preferred embodiment thereof, the frame comprises several subframes, two in this case. By convention, the first frame is made up of a group of allocated time intervals and the second subframe of a group of priority time intervals.

Practically speaking, the frame lasts 30 seconds and comprises 60 time intervals of 500 milliseconds. The two subframes each comprise 30 time intervals. The first subframe is comprised of the time intervals having an uneven digit place within the frame, and the second subframe is comprised of those having an even digit place within this frame. It thus appears that these two subframes are interleaved, this arrangement being substantiated below.

With reference to FIG. 1, a locating terminal TL is destined to a human being who is not totally autonomous (child, elderly person, disabled person), to a pet (dog, cat, horse) or to valuables of either financial or sentimental value (bicycle, boat, car, computer) that one wants to keep track of.

This locating terminal TL is designed so as to obtain its geographical position in one way or another, that is to say its space, or at the very least planar, co-ordinates. In this case, the GPS positioning system is made use of, and the terminal therefore includes spotting means in the form of a GPS antenna AGL coupled to a GPS receiver MGL.

These spotting means AGL, MGL are linked to a control unit such as a microcontroller MCL featuring its application software SWL. Data to the acquisition means, a RAM memory which, in this case, can be reduced to a first R1L register, are populated by the MCL microcontroller that provides them with a locating message. This message comprises essentially some position information relating to the terminal TL position, that corresponds to its coordinates in any reference system, such as its latitude, its longitude and possibly its altitude.

This first register R1L is used to transmit the locating message. Further details about this transmission operation are provided below.

Optionally, this locating message comprises some identifying information relating to the identification of the locating terminal TL, which is stored for example in a ROM-type memory (which stands for Read-Only Memory), a second register R2L in this case.

Considering the transmission data rate of 1,200 bits per second and the duration of a time interval, which lasts 500 ms, the maximum capacity of the first register R1L is then equal to the product of these two values, that is to say 600 bits. In practice, a safety margin of 40 bits is kept, so that a 560-bit register is considered, whose content is commonly called a transmission burst.

Typically, this data burst comprises:
possibly a header section,
possibly a synchronisation word,
imperatively a body,
possibly an end section.

This synchronisation word can be required when the two terminals exchanging this data burst are not synchronised in terms of the frequency or of the time to a common external reference.

The data burst body comprises the useful information, that which forms the subject of the transmission, and it accordingly contains the locating message.

The locating terminal TL also comprises communication means. Here these are transmission means tuned to the 869 MHz channel, that combine a radio transmitter MRL and a transmission antenna ARL. The transmitter is also linked to the microcontroller MCL.

It also comprises control means which can be integrated within the microcontroller MCL, to connect the acquisition means R1L to the radio transmitter MRL in response to an activation signal generated by a co-ordination unit which might also be integrated within the microcontroller. Thus, this activation signal triggers off the transmission burst.

It also comprises a counter CPL with a capacity that is equal to the number of time intervals in the frame, in this case 60. This counter is incremented by a clock signal coming from a time base BTL which issues a beep whenever the time interval changes, every 500 milliseconds in this case. It then indicates the sequence number within the frame for the current time interval.

The time base BTL is here synchronised to the GPS receiver MGL. It is also possible to provide a periodic resetting to zero of the counter CPL in order to prevent a possible drift of this counter.

The locating terminal TL also features a third register R3L that is used to synchronism the burst transmission. This register R3L is advantageously a memory of the EEPROM type (which stands for “Electrically Erasable PROgrammable Memory”). It identifies the sequence number within the frame for the time interval allocated to the terminal. The activation signal is generated by the co-ordination unit between the current value of the counter CPL and the value stored in the third register R3L. In this case, a logic gate LGL is used, which provides the logical AND function for these two values.

The third register R3L is initialised with an initialisation value that is permanently stored in the terminal TL. This value can even be inscribed on the casing of this terminal so that it can easily be accessible. The contents of this register can possibly be modified using a setting knob BRL whose operating mode is described below.

The various elements of the locating terminal TL are electrically supplied from a battery BAL, possibly connected to an internal charger CIL.

In this way, the locating message transmission is triggered off periodically within the same time interval of the successive frames, automatically without requiring any user action.

Moreover, simultaneously, the locating terminal TL is designed so as to manage emergency situations.

A first alarm signal originates from an immersion detector DIL and is produced for the intention of the microcontroller MCL. This detector is activated whenever the terminal TL is immersed, after falling in a swimming pool or accidentally falling over the railing on a ship, for example.

A second alarm signal originates from an emergency button BUL also connected to the microcontroller MCL. This button can be actuated by the user of the terminal TL under different circumstances:
actual or potential attack,
faintness fit, malaise,
panic,
incapacity to find one's way.

A third alarm signal originates from a shock detector CDL such as an accelerometer which also generates it for the intention of the microcontroller MCL. In this way an abnormal situation can be identified, no matter whether the terminal has fallen of its own or if it has been made to fall because the person carrying it has fallen.

Following the generation of any alarm signal whatsoever, the microcontroller MCL introduces an alarm word such as “SOS” in the locating message and the identification of the terminal TL (stored in the second register).

This alarm word can be substituted to the position information in the locating message, or a well identified place can be reserved to it within this message.

Moreover, it is also advisable to specify the nature of the situation which brought about the generation of this alarm signal. So, in the event of an occurrence of the first, second or third alarm signal, the alarm word comprises the respective information: “WATER”, “FIT” or “SHOCK”.

The locating terminal TL features a fourth register R4L initialised for a value which does not identify a time interval (in this case, an integer greater than 60). Advantageously, this register is also an EEPROM (Electrically Erasable PROgrammable Memory) which, upon the occurrence of any alarm signal, is charged by the sum modulo 60 of the double of the integer fraction of the half of the current value of counter CPL plus an offset value equal to 2n, where n is just any positive integer. It is then no longer modified until it is reset, and such resetting can take place in particular due to the occurrence of the activation signal, or to a time delay. The fourth register R4L thus identifies a priority time interval in the second subframe, namely the nth that follows the current time interval.

The microcontroller MCL is also programmed so as to generate the activation signal in the event of a match between the current value of the counter CPL and the value stored in the fourth register R4L.

This allows for rapid transmission of the alarm word, within the next priority time interval if n equals 1. It is not necessary to wait for the next allocated time interval of the terminal TL which can come about at the latest 30 seconds after the occurrence of an alarm signal. The reason why these two subframes are interleaved is now clearly demonstrated.

Moreover it is preferable to repeat the alarm word within one or several priority time intervals following that during which its first transmission took place.

It should also be noted that, if the microcontroller MCL does not modify the locating message, this alarm word will also be repeated within the next allocated time interval of terminal TL.

The arrangement of the subframes that has been applied until now leaves a significant place to priority time intervals. In order to increase the number of locating terminals that can simultaneously use this channel of 869 MHz, it is possible to reduce the size of the second subframe, by specifying for example that it comprises time intervals whose digit place within the frame is a multiple of 4.

With reference to FIG. 2, a surveillance terminal TS can be attributed to a person having under his/her custody a human being with reduced functional independence or a pet, for instance the father or mother of a young child or the owner of a dog.

It also comprises communication means. Here, these are reception means, combining a radio receiver MRS and a reception antenna ARS tuned to a channel of 869 MHz. The receiver MRS is also linked to a control unit such as a microcontroller MCS featuring its own application software SWS.

It also comprises acquisition means, that come here as a first reception memory M1S which is of the RAM type.

It further comprises control means that can be incorporated within the microcontroller MCS, to connect these acquisition means M1S to the radio receiver MRS in response to an activation signal.

Additionally, it comprises a counter CPS, the capacity of which equals the number of time intervals within the frame, 60 in this case. This counter is incremented by a clock signal coming from a time base BTS issuing a beep whenever the time interval changes, every 500 milliseconds in this case. So it indicates the sequence number in the frame of the current time interval.

Just as the locating terminal TL, the surveillance terminal TS receives from the GPS positioning signal, a reception signal via the determination means consisting of a GPS antenna AGS coupled to a GPS receiver MGS.

These determination means AGS, MGS are linked to the microcontroller MCS. Data to a second memory M2S of the RAM type, that can simply consist of a register, are populated by the microcontroller MCS that also provides a situation message. This message comprises for the most part some spot information in relation with the geographical situation of the surveillance terminal TS, corresponding to its coordinates in just any reference system, for example its latitude, its longitude and possibly its altitude.

The time base BTS is here synchronised to the GPS receiver MGS. It is also possible to provide a periodic resetting to zero of the counter CPS in order to prevent a possible drift of this counter.

The surveillance terminal TS also features a third memory M3S that is used to synchronism the burst reception. This third memory M3S identifies within the frame the sequence number for the time interval allocated to a locating terminal.

According to a first synchronisation method, the activation signal is produced by a coordination unit in the event of a match between the current value of the counter CPS and the value stored in the third memory M3S. In this case, a logical gate LGS is used to provide the logical AND function for these two values.

This memory is initialised with the initialisation value of the third register R3L of the locating terminal TL.

However, by the time this locating terminal is put into service, it can be that this initialisation value corresponds to a time interval of the frame which is already in use.

It is therefore advisable to identify by means of the radio receiver MRS of the surveillance terminal TS, which allocated time intervals are available within the channel in order to reserve one of these, the first one for example, to display it in any possible way and to load it into the third memory M3S. Such identification can typically be carried out by measuring the level received within these time intervals.

Let us specify now that the contents of the third register R3L of the locating terminal TL can be modified by means of the setting button BRL so as to retain obviously the time interval identified in the third memory M3S of the surveillance terminal TS.

A parameter setting mode of the locating terminal TL is provided for that purpose.

By way of example, this terminal TL being provided with a light emitting diode (LED), pressing a first time the setting button BRL brings about a temporary flashing of the LED while simultaneously starting a time delay.

Depressing this button again before the time delay has elapsed causes the terminal to enter the parameter setting mode. If the button is not actuated while that time delay is running, the terminal automatically enters the “normal operation” mode.

In the parameter setting mode, the content of the third register R3L is incremented by two units by pressing this button BRL.

According to a first option, a display device can be provided to that effect on the locating terminal TL to visualise the content of one's third register R3L.

According to a second option, provisions can be made for the locating terminal TL to transmit at very low power by the time it is put into service, as it is placed quite near the surveillance terminal TS. The locating terminal TL inserts an initialisation word within the locating message, it is then necessary to “play with” the setting button BRL until the surveillance terminal TS recognizes that initialization word. A second option makes it possible to relocate the synchronisation indication for the two terminals from the locating terminal TL to the surveillance terminal TS. In this case, the display device on the locating terminal TL is no longer required.

To exit the parameter setting mode, just any type of secure handling of the setting button BRL is to be provided, such as pressing the button twice successively within a short time period, or pressing the button just once for a relatively longer time.

The various elements of the surveillance terminal TS are electrically supplied. from a battery BAS, possibly connected to an internal charger CIS.

Within the surveillance terminal TS, the activation signal is also generated during all the priority time intervals of the second subframe.

According to a second synchronisation method of the surveillance terminal TS, the terminal also listens to all the allocated time intervals of the first subframe.

In this case, the third memory M3S contains an identification value which is not the time interval allocated to the locating terminal TL but the identification of this terminal TL. Of course, this terminal TL will by then have placed within this locating message the identification information stored in its second register R2L.

The activation signal is then generated by the coordination unit in the event of a match between the identification information and the identification value stored in the third memory M3S.

The present invention allows to choose from two synchronisation methods of the surveillance terminal TS. It would of course apply too to some other synchronisation method which is not described here.

The acquisition of the locating message is thus launched periodically, within the same time interval of the first successive subframes, and permanently during the second subframe, and thus automatically without requiring any user action.

If no alarm signal has been generated by the locating terminal TL, a new locating message from this terminal is available for each new frame within the surveillance terminal TS via the microcontroller MCS. This microcontroller MCS extracts the position information from the locating message on the one hand, and the spot information from the situation message on the other hand. It comprises means for calculating the distance between this position and this spot.

If this distance exceeds a first predetermined threshold, the surveillance terminal TS generates a first warning signal SUS either in the form of a light, acoustic or vibratory signal.

Likewise, if the traveling speed for the position of the locating terminal TL exceeds a second predetermined threshold, the surveillance terminal TS generates a second warning signal SVS identical to the first warning signal SUS.

The two above-mentioned thresholds can be input within the surveillance terminal TS using any man-machine interface, such as a keyboard.

In addition to that, this terminal TS comprises display means, for example a display screen EVS connected to the microcontroller MCS. If the latter can access a navigation system SNS, it is then possible to move a background map across this screen EVS so as to display by means of a dot or a cross the position of the locating terminal TL, and possibly its speed by means of a vector.

Preferably, the surveillance terminal TS also comprises a compass CES and a servo-control module (not shown) of the display means EVS. Thus, the map orientation is independent from the position of the terminal TS.

The surveillance terminal TS can also feature the indication of the direction in which the locating terminal TL is to be found. This indication can be included for example on the periphery of the screen EVS or on some other display means, it can also be in the form of an arrow superimposed upon the map background at the centre of which the surveillance terminal TS is situated.

Moreover, the distance between the two terminals TL, TS is displayed, just as is also the North indication.

If now an alarm signal has been generated by the locating terminal TL, a new locating message coming from this terminal is made available in the surveillance terminal TS as soon as it has been transmitted. Indeed, its microcontroller MCS keeps listening to all the time intervals of the second subframe. This microcontroller MCS comprises means to recognize the identification of the locating terminal TL in the locating message and, based on that, to extract the alarm word so as to convey its meaning in whichever way, i.e. visual and/or audible and/or vibratory.

Advantageously, the surveillance terminal TS is capable of following/monitoring several locating terminals. The means to be implemented to achieve that are readily accessible to the person skilled in the art, this having to do substantially with duplication. So this won't be described in any more detail. Let us simply specify that this terminal TS must have the identifications for all the locating terminals that it monitors. The information relating to these various terminals can be displayed successively or simultaneously providing that each terminal is identified by a distinctive graphic sign or by a specific colour.

The above example of an embodiment of this invention has been chosen due to its concrete nature. It would not be possible anyhow to list exhaustively all of the embodiment methods covered by this invention. In particular, any described means can be replaced by equivalent means without departing from the scope of this invention.

1. A terminal TL, TS comprising:
acquisition means R1L, M1S of a locating message,
communication means MRL-ARL, MRS-ARS,
control means MCL, MCS to connect said acquisition means and said communication means in response to an activation signal, characterised in that it also comprises a co-ordination unit MCL, MCS to automatically produce said activation signal, said control means being activated if and only if said activation signal is present.

2. The terminal according to claim 1, characterized in that said activation signal coincides with a predetermined time interval of a repetitive frame synchronised on a clock signal.

3. The terminal according to claim 2, characterized in that it comprises means BRL, MRS to position said predetermined time interval in said frame.

4. The terminal according to claim 2, characterised in that, said frame comprising a first subframe consisting of allocated time intervals and a second subframe consisting of priority time intervals, said predetermined time interval is an allocated time interval.

5. The terminal according to claim 4, characterised in that said subframes are interleaved.

6. The terminal according to claim 2, characterised in that said frame lasts 30 seconds and comprises 30 allocated time intervals of 500 ms and priority time intervals of 500 ms.

7. A locating terminal TL according to claim 1, characterised in that:
said acquisition means R1L come after spotting means AGL-MGL which receive a reception signal coming from a positioning system, and in that
said communication means are radio transmission means MRL-ARL.

8. The terminal according to claim 7, characterised in that said locating message comprises information relating to the position of said terminal TL.

9. The terminal according to claim 7, characterised in that said locating message comprises information relating to the identification of said terminal TL.

10. The terminal according to claim 7, characterised in that, said reception signal comprising a synchronisation information, it comprises means LGL, CPL, R3L to produce said activation signal in response to said synchronisation information.

11. The locating terminal according to claim 4, characterised in that,
said acquisition means R1L coming after spotting means AGL-MGL which receive a reception signal coming from a positioning system, and
said communication means being radio transmission means MRL-ARL,
it comprises means MCL, R4L to also produce, in response to an alarm signal, said activation signal at least in the nth priority time interval following the occurrence of said alarm signal, n being a predetermined number, and in that
it comprises means MCL to introduce an alarm word into said locating message.

12. The terminal according to claim 11, characterised in that it comprises means to repeat said alarm word in the first allocated time interval which follows said nth priority time interval.

13. The terminal according to claim 11, characterised in that said alarm signal originates from an immersion detector DIL.

14. The terminal according to claim 11, characterised in that said alarm signal originates from an emergency button BUL.

15. The terminal according to claim 11, characterised in that said alarm signal originates from a shock detector CDL.

16. A surveillance terminal TS according to claim 1, characterised in that
said acquisition means consist of a memory M1S, and
said communication means are reception means ARS-MRS.

17. The terminal according to claim 16 characterised in that, said locating message comprising an identifying information, said reception means ARS-MRS functioning uninterruptedly, it comprises another memory M3S in which an identification value is stored, said activation signal being produced by said co-ordination unit in the event of a match between said identifying information and said identification value.

18. The surveillance terminal TS according to claim 2, characterised in that:
said acquisition means consist of a memory M1S, and
said communication means are reception means ARS-MRS.

19. The terminal according to claim 16, characterised in that it comprises determination means AGS-MGS to produce a situation message in response to a reception signal coming from a positioning system.

20. The terminal according to claim 19 characterised in that, said reception signal comprising a synchronisation information, it comprises means LGS, CPS, M3S to produce said activation signal in response to said synchronisation information.

21. The terminal according to claim 19, characterised in that, said locating message comprising a position information, said situation message comprising a spot information, it comprises means MCS to calculate the distance between said position and said spot.

22. The terminal according to claim 21, characterised in that it produces a warning signal SUS if said distance exceeds a first predetermined threshold, this distance being a first measurement.

23. The terminal according to claim 21, characterised in that it produces a warning signal SVS if the traveling speed of said position exceeds a second predetermined threshold, this speed being a second measurement.

24. The terminal according to claim 22, characterised in that it comprises display means EVS of said measurement.

25. The terminal according to claim 24, characterised in that, comprising a compass CES, it comprises a slaving module of said display means EVS on said compass CES.

26. The terminal according to claim 21, characterised in that it comprises indicating means EVS of the direction of said position.

27. The surveillance terminal TS according to claim 4, characterised in that:
said acquisition means consisting of a memory M1S, said
said communication means being reception means ARS-MRS,
said locating message comprising an alarm word,
it comprises means MCS to also produce said activation signal response to this alarm word.

28. The terminal according to claim 27, characterised in that it comprises means to produce a warning signal SUS-SVS in response to said alarm word.

29. The terminal according to claim 4, characterised in that:
said acquisition means consisting of a memory M1S, and
said communication means being reception means ARS-MRS,
it comprises means ARS-MRS, MCS to identify a free allocated time interval.
